(19) United States
(12) Patent Application Publication
(10) Pub. No.: US 2015/0269654 A1
(43) Pub. Date: Sep. 24, 2015

(54) CONVENIENT ELECTRONIC COMMERCE

(71) Applicant: Infosys Limited, Bangalore (IN)

(72) Inventors: Vishnudatta Harihara Keshavamurthy, Mysore (IN); Sohin Vallabhaji Savla, Hyderabad (IN)

(73) Assignee: INFOSYS LIMITED, Bangalore (IN)

(21) Appl. No.: 14/614,281

(22) Filed: Feb. 4, 2015

(30) Foreign Application Priority Data
Mar. 20, 2014 (IN) 1486/CHE/2014

(51) Int. Cl. G06Q 30/06; G06Q 10/08; G06Q 20/10

(52) U.S. Cl. CPC G06Q 30/0635; G06Q 20/10; G06Q 10/087

(57) ABSTRACT

A method of increasing customer convenience in electronic commerce includes displaying a virtual inventory on a social media service, creating an association between an end user and one of a product and service linked to an organization on the social media service, collecting a set of preferences of the user onto a computer database, processing the end user preferences into a computer storage location, sending a notification to a mobile device linked to the end user, collecting user authentication at a physical location to disburse payment from an account linked to the end user on the social media service and on successful authentication from a computer server associated with the physical location, accepting a payment from an end user linked account into an organization linked account.

### FIELD

The field relates to a method, system and/or apparatus for improving convenience in electronic commerce.

### BACKGROUND

In today's world of mobile devices, we will soon see the day that Albert Einstein feared the most, the day when technology will surpass human interaction. Although the trend of mobile communication has been prevalent for about two decades, the advent of smartphones has changed mobile communication. The internet together with mobile devices is creating a communication revolution. Internet enabled smart phones have redefined communication, thanks to social media and accessibility of social media over smartphones. Coupled with this is the fact that the internet within itself is scaling new technology barriers with once unimaginable internet speeds on the desktop now being offered on mobile devices.

With the increase in variety of access to various systems, a user's ability to remember access credentials and utilize all the systems effectively has not increased. Although innovation has happened in various specific domains that would greatly increase uses the internet may provide to a user, it is still inherently required that the user access different systems to take advantage of different benefits while transacting on the internet.

### SUMMARY

Disclosed are a method, an apparatus and/or a system of increasing convenience in electronic commerce.

In one aspect, a method of increasing customer convenience in electronic commerce includes displaying a virtual inventory on a social media service, creating an association between an end user and one of a product and service linked to an organization on the social media service, collecting a set of preferences of the user onto a computer database, processing the end user preferences into a computer storage location, sending a notification to a mobile device linked to the end user, collecting user authentication at a physical location to instruct a disbursal of a payment from an account linked to the end user on the social media service and on successful authentication from a computer server associated with the physical location, initiate a transfer of the payment from an end user linked account into an organization linked account.

In another aspect, a system of increasing convenience in electronic commerce includes a virtual inventory, a social media service configured to display the virtual inventory. An association is created between an end user and at least one of a product and service linked to an organization on the social media service. A computer database collects a set of preferences of a user. A computer server communicatively coupled to the computer database is configured to process the end user preferences and a mobile device linked to the end user for receiving a notification is used. The system further includes, a physical location associated with the computer server for collecting user authentication. The user authentication is used to disburse payment from an account linked to the end user on the social media service and on successful authentication from the computer server associated with the physical location, a payment is accepted from an end user linked account into an organization linked account.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of an eco-system that improves customer convenience in electronic commerce, according to one or more embodiments.

FIG. 2 is a diagrammatic representation of a data processing system capable of processing a set of instructions to perform any one or more of the methodologies herein, according to one embodiment.

FIG. 3 is a process flow diagram detailing the operations of a method of increasing customer convenience in electronic commerce, according to one or more embodiments.

FIG. 4 is a block diagram of creating a convenience electronic commerce eco-system, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of increasing convenience in electronic commerce. Although the present embodiments have been described with reference to specific example embodiments, it will be evident that various modifications and changes may be made to these embodiments without departing from the broader spirit and scope of the various embodiments.

In one or more embodiments, virtual inventory may be an enterprise resource planning (ERP) systems that are linked to social media. Social media may be social media platforms and/or services offered over the internet. In one or more embodiments, ERP systems may be business management software that is usually a suite of integrated applications that a company may use to store and manage data from every stage of business, including: product planning, costs associated, development, manufacturing, marketing, sales, inventory management, shipping and payment.

Further, social media platforms may be social networking services such as Facebook™, Twitter™, and Pinterest™. In one or more embodiments, social networking services may require users to register before using the social networking services, after which the users may create a personal profile, add other users as friends, exchange messages, and receive automatic notifications when the users update the personal profile. Additionally, users may join common-interest user groups, organized by workplace, school and/or college and/or university, or other characteristics, and categorize friends into lists such as “People From Work” or “Close Friends”. Further, social network services may allow users to follow activities and posts of other users.

In one or more embodiments, inventory management of an ERP system may be associated with a social media link. Social media link may be a page on a social media platform such as Facebook™.

In one or more embodiments, as soon as a new product is available to be rolled out by a company/organization, the inventory management's social media link may be updated with the new product details. Thereby, social media may help the company/organization reach an interested user group directly. A user may be associated with inventory management connected social media link. The inventory management's social media link may be a social media page. The user may have expressed a liking or association with the social media page. Thereby, the user could like the product and provide a preference(s). With help of location based services, the user may be notified about the liked product's availability and/or discount in a nearby store.

In one or more embodiments, payments could be in the form of accepting a payment request from the social media page and paying using a pre-linked payment sources securely on the social media platform. In one or more embodiments, the payment may be one of in-store payments, over the internet payments, near field communication (NFC) enabled payments, mobile wallet such as Google wallet™.

In one or more embodiments, for the user, a single channel may be created for end-to-end commerce cycle. The location based services may help the user save time by reminding and allowing them to shop at a time most convenient to the user. In an example embodiment, the payment could be NFC enabled which may send the user a payment request through the social media platform. Thus, a user experience may be significantly enhanced. In an example embodiment, the user may be offered user discount coupons as a reward as and when the user tags the product. For example, the user may tag the product through one of a text status, uploaded image, addressing on micro blogging service and so on.

In an example embodiment, if the user may have worn a product in an uploaded picture on the social media platform, the user may be offered discount coupons. Other users apart from liking the uploaded picture could also be enabled to like the product and give preference(s). The discount coupons could be leveled off at the time of accepting the payment request.

In an integrated world the challenge is to combine advantages that multiple systems provide. There exists a lack of being able to combine advantages that multiple systems provide in-silos. For example, prepaid mobile balance recharge sites may offer coupons on every successful recharge over the internet as opposed to recharge over a counter at a physical location. Payment service providers such as Paypal™ offer simplified payment processing. Payment processing may be simplified by allowing the user to upload payment card details as a one-time activity and make a secure electronic-commerce payment without a need of entering card details for every transaction. Online marketplaces such Amazon™ are offering cash on delivery services in India. Cash on delivery as a service has multiple advantages in markets where there may be a trust deficit. Cash on delivery may offer a convenience that other forms of payment fail to offer. Further, social media marketing has seen investments by organizations based on behavioral analysis of social media users. Innovations that may be logically connected to electronic commerce has seen innovation in-silos. An eco-system to combine effectively the innovations in multiple domains would benefit the user and the organizations.

By effectively combining the multiple innovations in logically connected areas a prediction of a customer need may be made.

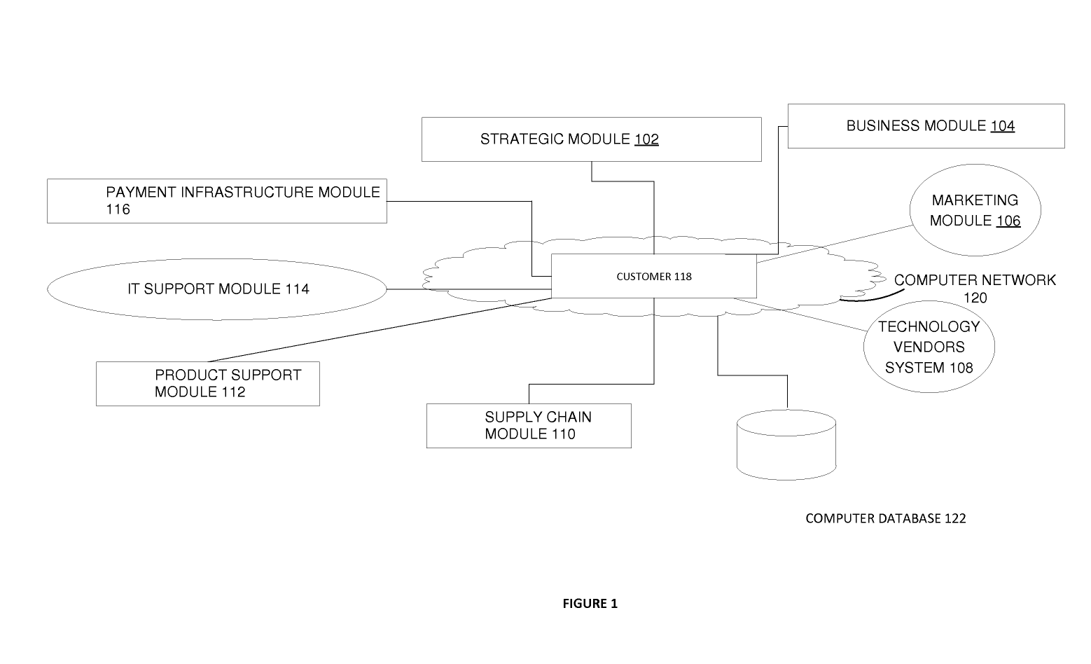

FIG. 1, is a block diagram detailing components involved in an eco-system that improves customer convenience in electronic commerce, according to one or more embodiments. In one or more embodiments, an eco-system of increasing convenience in electronic commerce may include a strategic module 102, business module 104, marketing module 106, Technology vendors system 108, Supply Chain module 110, product support 112, Information Technology module 114 and Payment infrastructure 116 that may be communicatively coupled to a customer module 118 over a computer network 120. The computer network may be associated with a computer database 122. Transactions over the computer network 120 may be stored onto the computer database 122. In one or more embodiments, the computer network 120 may be communication network facilitating communication as for example data bytes.

In one or more embodiments, there may be significant time lag between influencing customer opinions on products and an actual purchase of the product by the customer. One of the reasons for the time lag may be a lack of an availability of time for the customer to make the actual purchase. When a brand/organization may attempt to save time for the customer then the attempt may increase a convenience for the customer. Similarly, reduction in costs associated with influencing the customer opinion through marketing campaigns may result in increase of convenience for the brand/organization.

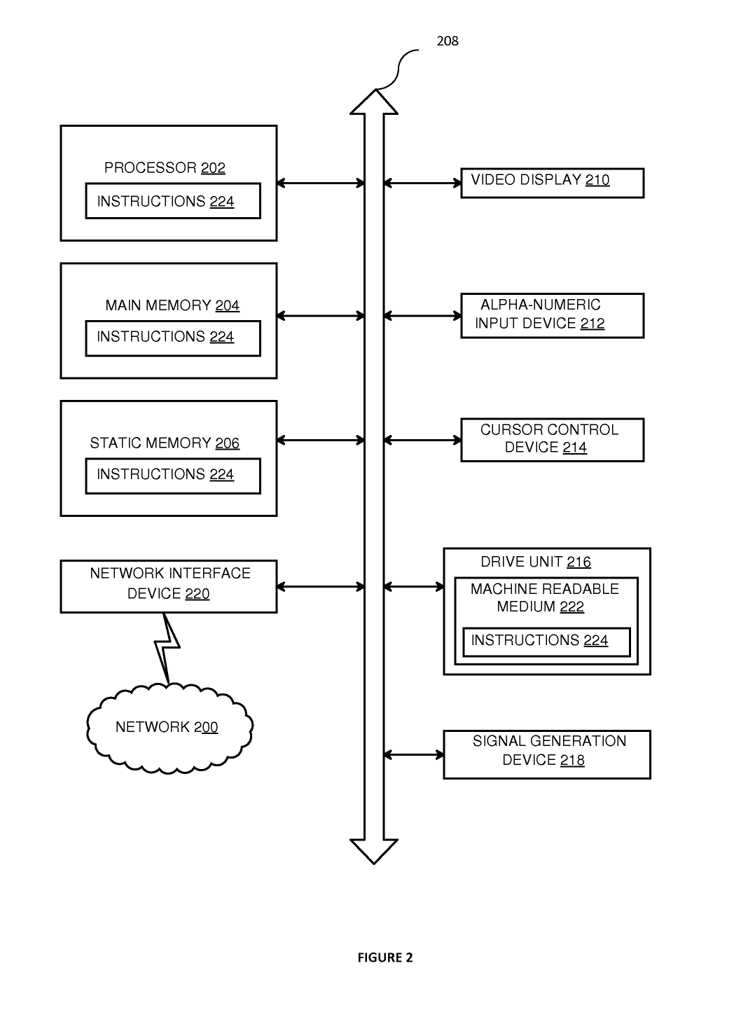

FIG. 2 is a diagrammatic representation of a data processing system capable of processing a set of instructions to perform any one or more of the methodologies herein, according to an example embodiment. FIG. 2 shows a diagrammatic representation of machine in the example form of a computer system 200 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and or as a peer machine in a peer-to-peer (or distributed) network environment. The machine may be a personal-computer (PC), a tablet PC, a set-top box (STB), a Personal Digital Assistant (PDA), a cellular telephone, a web appliance, a network router, switch and or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 200 includes a processor 202 (e.g., a central processing unit (CPU) a graphics processing unit (GPU) and/or both), a main memory 204 and a static memory 206, which communicate with each other via a bus 208. The computer system 200 may further include a video display unit 210 (e.g., a liquid crystal displays (LCD) and/or a cathode ray tube (CRT)). The computer system 200 also includes an alphanumeric input device 212 (e.g., a keyboard), a cursor control device 214 (e.g., a mouse), a disk drive unit 216, a signal generation device 218 (e.g., a speaker) and a network interface device 220.

The disk drive unit 216 includes a machine-readable medium 222 on which is stored one or more sets of instructions 224 (e.g., software) embodying any one or more of the methodologies and/or functions described herein. The instructions 224 may also reside, completely and/or at least partially, within the main memory 204 and/or within the processor 202 during execution thereof by the computer system 200, the main memory 204 and the processor 202 also constituting machine-readable media.

The instructions 224 may further be transmitted and/or received over a network 226 via the network interface device 220. While the machine-readable medium 222 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

In one or more embodiments, social media platforms may be social networking services such as Facebook™, Twitter™, and Pinterest™. In one or more embodiments, social networking services may require users to register before using the social networking services, after which the users may create a personal profile, add other users as friends, exchange messages, and receive automatic notifications when the users update the personal profile. Additionally, users may join common-interest user groups, organized by workplace, school and/or college and/or university, or other characteristics, and categorize friends into lists such as “People From Work” or “Close Friends”. Further, social network services may allow users to follow activities and posts of other users.

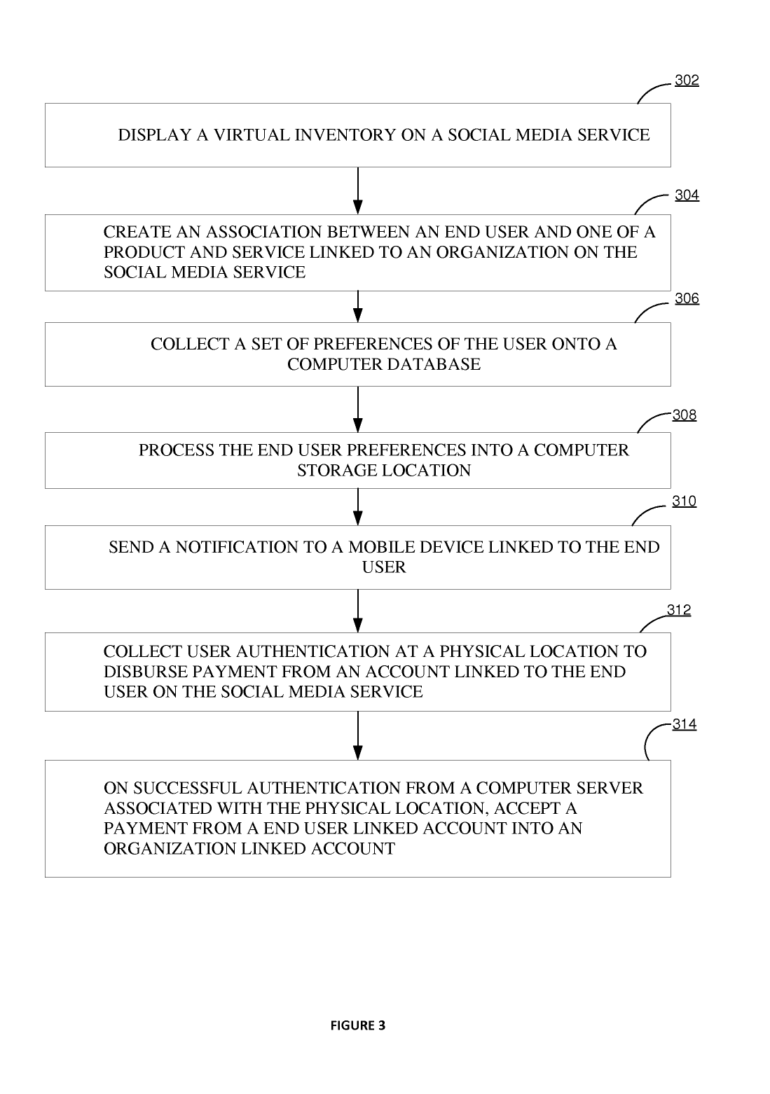

FIG. 3 is a process flow diagram detailing the operations of a convenience electronic commerce, according to one or more embodiments. In one or more embodiments, a method of increasing customer convenience in electronic commerce may include displaying a virtual inventory on a social media service 302, creating an association between an end user and one of a product and service linked to an organization on the social media service 304, collecting a set of preferences of the user onto a computer database 306, processing the end user preferences into a computer storage location 308, sending a notification to a mobile device linked to the end user 310, collecting user authentication at a physical location to disburse payment from an account linked to the end user on the social media service 312 and on successful authentication from a computer server associated with the physical location, accepting a payment from an end user linked account into an organization linked account 314.

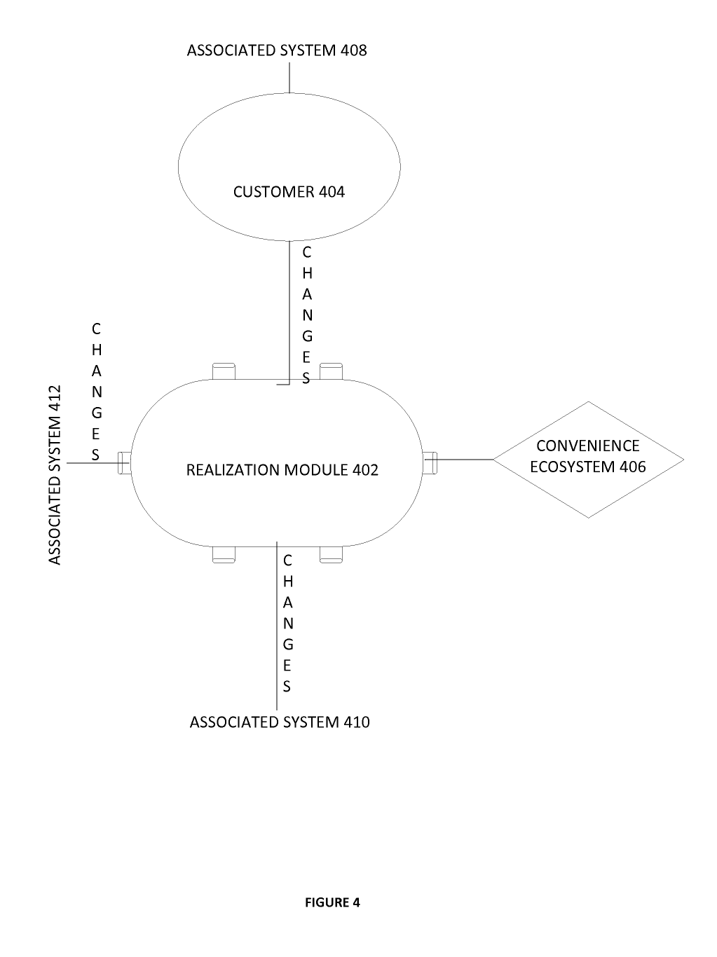

FIG. 4 is a block diagram of creating a convenience electronic commerce eco-system, according to one embodiment. In an example embodiment, a system to create a convenience electronic commerce system may include a realization module 402 communicatively coupled to a convenience eco-system 406. Further, a customer 404 may be coupled to the realization module 402. In one or more embodiments, the realization module 402 may help in absorbing changes occurring in various associated systems such as associated system 408, associated system 410, and associated system 412. In one or more embodiments, associated systems may be individual systems that were previously operating in-silos now being brought into the convenience eco-system 406.

In an example embodiment, a system of convenience commerce may include a personal finance manager. Currently, users of financial systems may face worries with financial planning Financial planning tools of the past may look at a customer's income, savings and expenditure pattern and predict an amount of money to be set aside to achieve a defined financial goal. However, the system of convenience commerce may go one step ahead by creating an eco-system that will link and keep a track of all the expenses and income sources of the customer. In an example embodiment, income sources of the customer such as bank accounts, utility service providers, general grocery store payments etc. may all be serviced through the system of convenience commerce by integrating with service providers.

In another example embodiment, the system may also allow the customer to define individual wallet accounts for needs like entertainment wallet, grocery wallet, holiday wallet etc. with configurable limits and reminders to fund the wallets accounts at pre-defined intervals. Standing instruction for bill payments may also be set-up.

With data readily available in the system, all that the user may now need is to define a financial goal. Once the goal is defined, the system would be capable of analyzing the shortfall and/or surplus of funds.

The customers may then be provided with various options to meet the shortfall if any. The system may compare the customer's utility expenses and offer alternative options to save money. For example, say if the user is currently subscribed to XYZ Power for electricity which charges more that ABC power, the system may prompt the customer informing the customer about such expense cutting options. Alternately, the system could enable the user to avail of a bank loan by presenting the customer with comparative loan analysis from various banks.

The various banks could use the customer's bill payment history for unbanked customers to arrive at their credit score and promote a customer's financial inclusion goals.

Some advantages of the system may include, saving the customers time and money and helps the customers establish and fulfill financial goals. Additionally, customers may create payment history thereby ensuring access to bank's credit facility. Also, the various banks may have an advantage in increasing the banks' reach, promoting financial inclusion goals and encouraging cash-less payments by reducing overall costs to the banks.

Further, service providers may be benefited by prompt user payments and reduced costs. The system may also ensure healthy market competition by encouraging informed decision making processes.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What is claimed is:

1. A computer implemented method of electronic commerce comprising:
displaying a virtual inventory on a social media service;
creating an association between an end user and at least one of a product and service linked to an organization on the social media service;
collecting a set of preferences of the user onto a computer database;
processing the end user preferences into a computer storage location associated with the computer database;
sending a notification to a mobile device linked to the end user;
collecting user authentication at a physical location to instruct a disbursal of a payment from an account linked to the end user on the social media service; and
on successful authentication from a computer server associated with the physical location, initiating a transfer of the payment from an end user linked account into an organization linked account.

2. A computer implemented method of claim 1, wherein the organization is associated with the social media service through a computer network.

3. A computer implemented method of claim 1, wherein the preferences include one of products, service, features of service or features of products.

4. A computer implemented method of claim 1, wherein the notification includes a location tag, confirmation of receiving preferences, security information, location of store and detail of store.

5. A computer implemented method of claim 1, further comprising:
accepting the payment includes redemption of a discount coupon associated with one of the product and the service of the organization.

6. A computer implemented method of claim 1, further comprising:
accepting feedback from the end user on the page associated with the organization on the social media service.

7. A computer implemented method of claim 1, wherein the storage location is communicatively coupled to a supplier and supply chain associated with the organization.

8. A system of increasing convenience in electronic commerce comprising:
a virtual inventory;
a social media service configured to display the virtual inventory,
wherein an association is created between an end user and at least one of a
product and service linked to an organization on the social media service;
a computer database that collects a set of preferences of a user;
a computer server communicatively coupled to the computer database configured to process the end user preferences;
a mobile device linked to the end user for receiving a notification;
a physical location associated with the computer server for collecting user authentication,
wherein the user authentication is used to instruct a disbursal of a payment from an account linked to the end user on the social media service; and
on successful authentication from the computer server associated with the physical location, initiating a transfer of the payment from an end user linked account into an organization linked account.

9. The system of claim 8, wherein the organization is associated with the social media service through a computer network.

10. The system of claim 8, wherein the preferences include one of products, service, features of service or features of products.

11. The system of claim 8, wherein the notification includes a location tag, confirmation of receiving preferences, security information, location of store and detail of store.

12. The system of claim 8, further comprising:
accepting the payment includes redemption of a discount coupon associated with one of the product and the service of the organization.

13. The system of claim 8, further comprising:
accepting feedback from the end user on the page associated with the organization on the social media service.

14. The system of claim 8, wherein the storage location is communicatively coupled to a supplier and supply chain associated with the organization.

15. One or more non-transitory computer-readable media having encoded thereon computer-executable instructions that, when executed, cause a computing system to perform a method comprising:
displaying a virtual inventory on a social media service;
creating an association between an end user and at least one of a product and service linked to an organization on the social media service;
collecting a set of preferences of the user onto a computer database;
processing the end user preferences into a computer storage location associated with the computer database;
sending a notification to a mobile device linked to the end user;
collecting user authentication at a physical location to instruct a disbursal of a payment from an account linked to the end user on the social media service; and
on successful authentication from a computer server associated with the physical location, initiating a transfer of the payment from an end user linked account into an organization linked account.
